(19) United States
(12) Patent Application Publication
(10) Pub. No.: US 2014/0149375 A1
(43) Pub. Date: May 29, 2014

(54) SYSTEM AND METHOD FOR PROVIDING PREDICTIVE QUERIES

(71) Applicant: ESTsoft Corp., Seoul (KR)

(72) Inventor: Kun-Young SON, Seoul (KR)

(73) Assignee: ESTsoft Corp., Seoul (KR)

(21) Appl. No.: 14/077,145

(22) Filed: Nov. 11, 2013

(30) Foreign Application Priority Data
Nov. 28, 2012 (KR) 10-2012-0136112

(51) Int. Cl. G06F 17/30

(52) U.S. Cl. CPC G06F 17/30448
USPC 707/706

(57) ABSTRACT

A system and method provide predictive queries associated with a search query entered by a user even though such a query input is entered incompletely. In addition, even in case a user enters incompletely a wrong query, the system and method provide predictive queries based on a correct query by using index information derived from calculation in the probability of a correct query.

### TECHNICAL FIELD

The present invention relates to search technology and, more particularly, to a system and method for providing predictive queries.

### BACKGROUND

With the Internet popularized in these days, a great variety of services such as a search service have been provided on the basis of the Internet. In a search service based on the Internet, when a user enters a keyword or a combination of keywords as a search query, a search engine performs a search process in response to a search query and then offers search results to a user. Normally search results include web sites, news, images having titles containing the search query, and the like.

A search service is improving toward maximization of user convenience. Namely, a search service is being developed to offer satisfactory search results in response to any appropriate search query and also to offer helpful search results even in case of any inappropriate search query. Especially, for users who have no background knowledge about appropriate search queries, various search services have been developed and proposed to give users a guide to appropriate search queries.

For example, let's suppose that a user desires to obtain search results about a query “galaxy”. Referring to FIG. 1, even though a user enters incompletely a query “gal” only in a query input window 12 on a search screen 10, a search engine provides various predictive queries such as “galaxy s4”, “galaxy note 3”, “galaxy s4 active”, and “gallstones” in a predictive query list 16. Therefore, a user can simply select a desired one of predictive queries and then click a search button 14 without the need to enter a complete query.

Meanwhile, a user may sometimes make typing errors when entering a query. In this case, a search engine performs a search process based on a wrong query entered actually and then offers search results to a user. Since these results are based on a wrong query, a user may fail to obtain desired search results. Referring to FIG. 2, when a user enters incompletely a wrong query “gall” instead of a correct query “galaxy”, a search engine may not recognize typing errors and hence provide some predictive queries such as “gallbladder”, “gallstones”, “galleria mall”, and “galls” which have a common character string with a query “gall”. Because most of such predictive queries have no relation to user's desired query, a user has to receive unsatisfied search results and/or should enter again a search query. This may cause inconvenience to a user, thus being followed by deterioration in service reliability and in customer satisfaction.

In order to solve the above problem, some typical search sites have used an error correction engine to correct a wrong query entered by a user. This error correction engine compares a search query with dictionary database and then suggests a correct query. For example, if a user enters completely a search query “gallaxy”, a typical search site having an error correction engine may suggest search queries as shown in FIG. 1 together with offering an expression (e.g., “Are you searching for galaxy?”).

However, since such an error correction engine depends on pre-constructed dictionary database only, search queries suggested as correct queries are quite limited. Additionally, a great variety of queries entered in every minute are not sufficiently reflected, and there is not much probability that correct queries suggested by an error correction engine will be always correct queries in a lexical meaning. Furthermore, a real-time error correction process for every query entered by users seriously increases a server load. Moreover, in case a search is performed using a search query suggested by an error correction engine, various predictive queries as shown in FIG. 2 may not be provided and therefore a user should enter again a correct search query. Namely, typical search sites merely provide a suggested query which reflects a user's entered wrong query as it is, and further fails to know whether a user's entered query is wrong until a user enters a complete query.

### SUMMARY

Accordingly, to address the above-mentioned problems and/or disadvantages and to offer at least the advantages described below, the present invention provides a system and method for providing predictive queries based on a correct query even though a user enters incompletely and mistakenly a wrong query.

According to one aspect of the present invention, provided is a system for providing predictive queries to a search system having an error correction engine which performs an error correction process for a search query entered by a user and offers a suggested correct query. This system may comprise a search log database configured to store search queries entered by users; a recommended predictive query list creating unit configured to create a recommended predictive query list that contains at least one keyword to be provided as the predictive query from the search log database; an error correction log database configured to store a query pair of a wrong query entered by a user and the suggested correct query offered by the error correction engine and accepted by a user; a correct query probability calculation unit configured to calculate probability of a correct query with regard to a specific keyword contained in the recommended predictive query list by reading the error correction log database and then comparing the number of wrong queries containing the specific keyword with the number of correct queries containing the specific keyword; a wrong query list creating unit configured to select the specific keyword as a correct query on the basis of the calculated probability and also to create a wrong query list by extracting wrong queries from query pairs having the specific keyword as suggested correct queries among the query pairs in the error correction log database; a query indexing unit configured to create index information about correct queries and about wrong queries with regard to the specific keyword on the basis of both the recommended predictive query list and the wrong query list; and a predictive query creating unit configured to retrieve index information from the query index database and to find a predictive query having the same index information as that of a currently entered query.

In this system, the index information may be a linear arrangement of letter units, phoneme units, syllable units, or suffix units derived from separation of each correct query or each wrong query.

According to another aspect of the present invention, provided is a search system that includes the aforesaid predictive query providing system.

According to still another aspect of the present invention, provided is a method for providing predictive queries to a search system having an error correction engine which performs an error correction process for a search query entered by a user and offers a suggested correct query. This method may comprise recording, in a search log database, search queries entered by users and also recording, in an error correction log database, a query pair of a wrong query entered by a user and the suggested correct query offered by the error correction engine and accepted by a user; creating a recommended predictive query list that contains at least one keyword to be provided as the predictive query from the search log database; calculating probability of a correct query with regard to a specific keyword contained in the recommended predictive query list by reading the error correction log database and then comparing the number of wrong queries containing the specific keyword with the number of correct queries containing the specific keyword; selecting the specific keyword as a correct query on the basis of the calculated probability and then creating a wrong query list by extracting wrong queries from query pairs having the specific keyword as suggested correct queries among the query pairs in the error correction log database; creating index information about correct queries and about wrong queries with regard to the specific keyword on the basis of both the recommended predictive query list and the wrong query list; and finding a predictive query having the same index information as that of a currently entered query by retrieving index information from the query index database.

In this method, the index information may be a linear arrangement of letter units, phoneme units, syllable units, or suffix units derived from separation of each correct query or each wrong query.

According to yet another aspect of the present invention, provided is a computer-readable storage medium storing therein a program executing the aforesaid predictive query providing method.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

FIGS. 1 and 2 show conventional search screens in which predictive queries are provided in response to an incomplete query input.

FIG. 3 is a block diagram illustrating a system for providing predictive queries in accordance with an embodiment of the present invention.

FIG. 4 is a flow diagram illustrating a method for providing predictive queries in accordance with an embodiment of the present invention.

FIG. 5 shows error correction log database that records a pair of a wrong query entered by a user and a suggested correct query offered by an error correction engine and accepted by a user, in accordance with an embodiment of the present invention.

FIG. 6 shows query index database that records relations among a specific keyword, related index information and a predictive query, in accordance with an embodiment of the present invention.

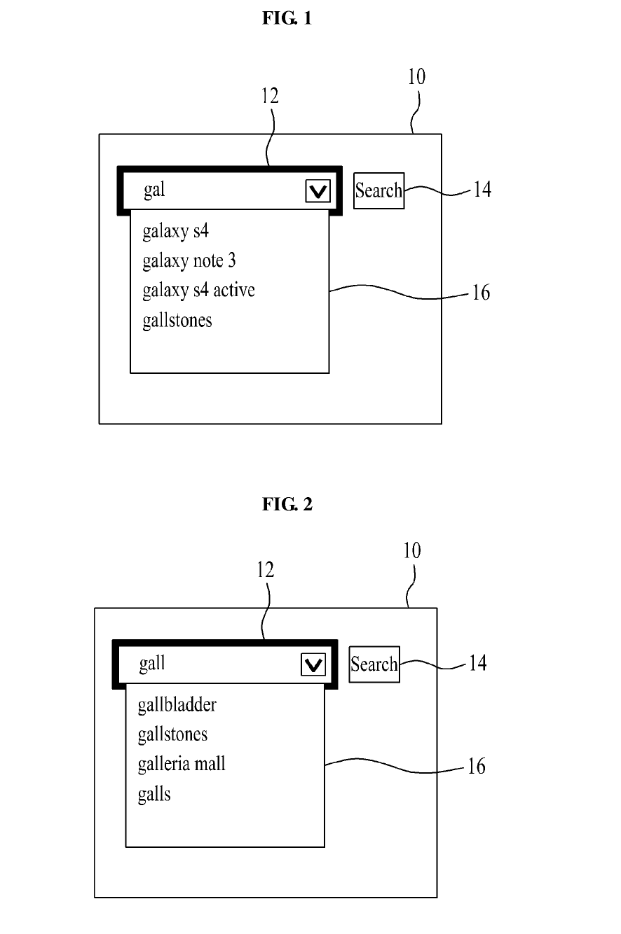

### DETAILED DESCRIPTION

The following description with reference to the accompanying drawings is provided to assist in a comprehensive understanding of various embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the present invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present invention is provided for illustration purpose only and not for the purpose of limiting the present invention as defined by the appended claims and their equivalents.

It is to be understood that the singular forms “a,” “an,” and “the” include plural referents unless the context clearly dictates otherwise. Thus, for example, reference to “a query” includes reference to one or more of such queries.

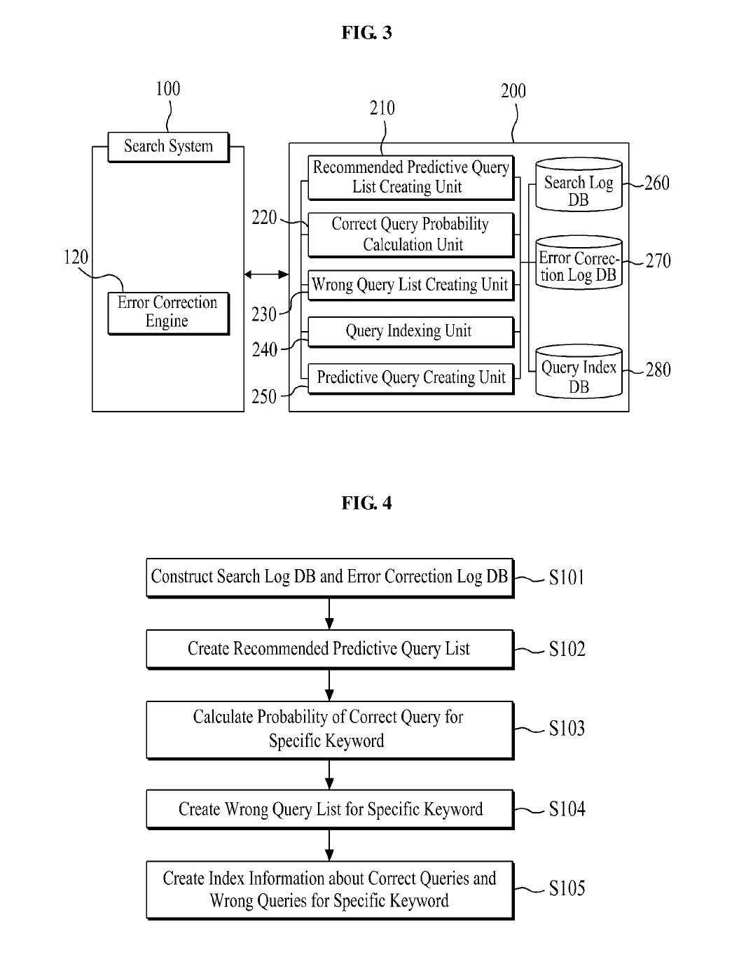

FIG. 3 is a block diagram illustrating a system for providing predictive queries in accordance with an embodiment of the present invention. Referring to FIG. 3, a predictive query providing system 200 is configured to provide predictive queries to a search system 100 that offers a search service based on the Internet and includes an error correction engine 120. The predictive query providing system 200 may be incorporated in the search system 100 or constructed as a physically separate system which can communicate with the search system 100 through a network. The error correction engine 120 has dictionary database such as an English dictionary, a Korean language dictionary, an encyclopedia, and the like. Using such dictionary database, the error correction engine 120 performs an error correction process for a search query entered by a user and then offers a suggested correct query. In this case, a user can select a suggested correct query and request a search based on a suggested correct query. The error correction engine 120 may be realized in various forms used in typical search systems, and thus detailed descriptions will be omitted herein.

FIG. 4 is a flow diagram illustrating a method for providing predictive queries in accordance with an embodiment of the present invention. Now, elements of the predictive query providing system 200 and related process will be described in detail with reference to FIGS. 3 and 4.

At the outset, a search log database 260 stores search queries entered by users through the search system 100. Specifically, the search log database 260 stores information about a user's search request, i.e., search log information including a user identifier, a search query entered by a user, a search time, and the like. The search log database 260 may record log information about all search actions.

An error correction log database 270 interacts with the error correction engine 120 in the search system 100. The error correction engine 120 may conclude that a search query entered by a user is wrong, and hence offer a suggested correct query. If a user accepts a suggested correct query and then requests a search based on a suggested correct query, a query pair of a wrong query entered by a user and a suggested correct query accepted by a user is created. Such query pairs are recorded in the error correction log database 270. FIG. 5 to be described later shows an example of the error correction log database 270.

At step S101, the predictive query providing system 200 constructs in advance both the search log database 260 and the error correction log database 270 from data accumulated with regard to various users for a considerable time.

Next, at step S102, a recommended predictive query list creating unit 210 creates a recommended predictive query list that contains at least one keyword to be provided as a predictive query from the search log database 260. For example, the recommended predictive query list creating unit 210 may create the recommended predictive query list by selecting at least one keyword (preferably, the predetermined number of keywords) among search queries recorded in the search log database 260 according to a predefined rule such as a search frequency, a search result click rate, or the like.

After the recommended predictive query list is created, at step S103 a correct query probability calculation unit 220 calculates the probability of a correct query with regard to each keyword contained in the recommended predictive query list.

Specifically, for a specific keyword, the correct query probability calculation unit 220 reads the error correction log database 270 and then, from query pairs recorded in this database 270, compares the number of wrong queries containing the specific keyword with the number of correct queries containing the specific keyword. For example, let's suppose the error correction log database 270 records query pairs as shown in FIG. 5. Herein, the term “wrong query” refers to a search query mistakenly entered by a user, the term “suggested correct query” refers to a search query offered as a correct query by the error correction engine 120 and accepted by a user, and the term “number of query pairs” refers to the number of instances where the same wrong query is entered and the same suggested correct query is accepted. Namely, a query pair having a relatively greater number means a wrong query frequently entered by users and a suggested correct query frequently accepted by users.

If the recommended predictive query list contains a specific keyword “estsoft”, this keyword “estsoft” appears thirty-three times in suggested correct queries and also appears twice in wrong queries as shown in FIG. 5. Therefore, the probability that the keyword “estsoft” is a correct query has a value “1” according to the following Equation 1 (namely, P=Min{1, 33/2}).

P(keyword)=Min{1, C(keyword)/W(keyword)} [Equation 1]

In Equation 1, the term “P(keyword)” denotes the probability that a specific keyword is a correct query, the function “Min{1, A}” denotes the minimum value between numeral values “1” and “A”, the term “C(keyword)” denotes the number of cases where a specific keyword appears in suggested correct queries, and the term “W(keyword)” denotes the number of cases where a specific keyword appears in wrong queries.

Namely, the probability value P approaches to “0” if a specific keyword appears much more in wrong queries. In contrast, the probability value P becomes “1” if a specific keyword appears much more in suggested correct queries.

After the correct query probability calculation unit 220 calculates the probability of a correct query with regard to each keyword contained in the recommended predictive query list, a wrong query list creating unit 230 not only selects a specific keyword as a correct query on the basis of the calculated probability, but also extracts wrong queries from query pairs having the specific keyword as suggested correct queries among query pairs in the error correction log database 270. Namely, at step S104, the wrong query list creating unit 230 creates a wrong query list for a specific keyword selected as a correct query such that the wrong query list includes wrong queries contained in query pairs having the specific keyword as suggested correct queries. Specifically, the wrong query list creating unit 230 may select, as a correct query, a specific keyword having the probability value P which is equal to or greater than a given reference value. For example, this reference value may be “1” and, if necessary, may be changed to other suitable value such as “0.75”, “0.5”, or the like. In an example shown in FIG. 5, a specific keyword “estsoft” is selected as a correct query because the probability value P is “1”. In this case, from query pairs containing the specific keyword “estsoft” as suggested correct queries, wrong queries “eastsoft” and “estasoft” are extracted for a wrong query list.

Next, at step S105, a query indexing unit 240 creates index information about correct queries and about wrong queries with regard to the specific keyword on the basis of both the recommended predictive query list and the wrong query list. Herein, index information may be a linear arrangement of letter units, phoneme units, syllable units, and/or suffix units derived from separation of each correct query or each wrong query.

For example, index information about a specific English query “phoneme” may be a linear arrangement of letter units “p”, “h”, “o”, “n”, “e”, “m” and “e”, a linear arrangement of phoneme units “ph”, “o”, “n”, “e” and “me”, or a linear arrangement of syllable units “pho” and “neme”.

In another example, index information about a specific Korean language query “ [symbol] ” (which means a donkey and is pronounced as ta [symbol] .na.gwi) may be a linear arrangement of phoneme units “ [symbol] ”, “ [symbol] ”, “ [symbol] ”, “ [symbol] ”, “ [symbol] ”, “ [symbol] ” and “ [symbol] ”, a linear arrangement of syllable units “ [symbol] ”, “ [symbol] ” and “ [symbol] ”, or a linear arrangement of suffix units “ [symbol] ”, “ [symbol] ” and “ [symbol] ”.

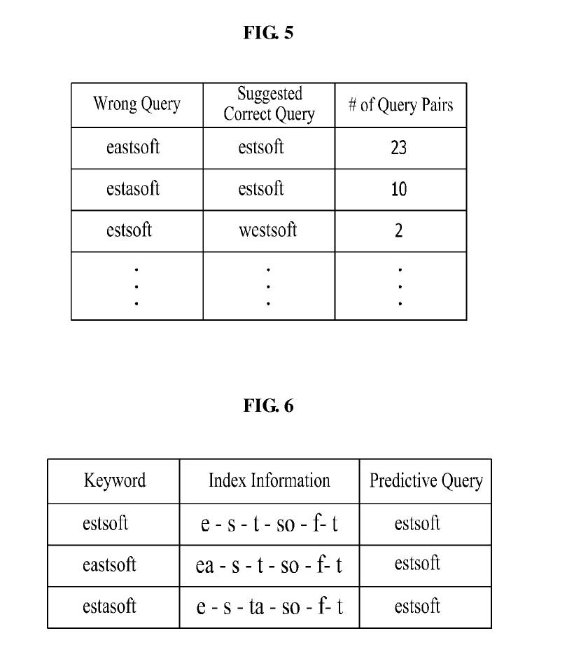

Such index information created as a linear arrangement of letter units, phoneme units, syllable units, and/or suffix units is linked to the relevant specific keyword and a related predictive query, and then recorded by the query indexing unit 240 in query index database 280 as shown in FIG. 6.

FIG. 6 shows an example of the query index database 280 that records relations among a specific keyword, related index information, and a predictive query”. In this example, index information is created as a linear arrangement of phoneme units with regard to each of a correct query and wrong queries in connection with a specific keyword “estsoft”.

If a user is starting to enter a certain search query after the query index database 280 is created as discussed above, a predictive query creating unit 250 retrieves index information from the query index database 280 and finds a predictive query having the same index information as that of a currently entered query. Then the predictive query creating unit 250 provides the found predictive query to the search system 100. For example, if a user enters an incomplete query “esta”, this may be a part of a correct query “estate” or a part of a wrong query “estasoft” which corresponds to a correct query “estsoft”. In this case, index information of a currently entered query “esta” is “e-s-ta”, which is equally contained in index information of a correct query “estate” and a wrong query “estasoft”. Therefore, the predictive query creating unit 250 provides a predictive query “estate” liked to a correct query “estate” and a predictive query “estsoft” linked to a wrong query “estasoft”.

This technique to provide predictive queries in the present invention is different from a typical technique, as follows. For example, if a user who desires to search for “galaxy” enters incompletely and mistakenly a specific query “gall”, a typical search system merely provides predictive queries based on the entered specific query as discussed in FIG. 2. However, in the same case, this invention can provide suitable predictive queries for a correct query “galaxy” because it has been estimated in advance that a keyword “galaxy” is a wrong query corresponding to “galaxy” and because related index information has been already recorded in the query index database.

As fully discussed hereinbefore, the system and method of this invention can provide predictive queries associated with a search query entered by a user even though such a query input is entered incompletely. Particularly, even in case a user enters incompletely a wrong query input, the system and method of this invention can provide predictive queries based on a correct query by using index information derived from calculation in the probability of a correct query. Additionally, since the system and method of this invention can provide predictive queries by constructing in advance database regarding mapping relations between correct queries and index information about frequently entered wrong queries, a search process may not need a real-time error correction that causes a serious increase in a server load.

The above-discussed predictive query providing method is described herein with reference to flowchart illustrations of user interfaces, methods, and computer program products according to embodiments of the present disclosure. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which are executed via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that are executed on the computer or other programmable apparatus provide steps for implementing the functions specified in the flowchart block or blocks.

And each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

While this invention has been particularly shown and described with reference to an exemplary embodiment thereof, it will be understood by those skilled in the art that various changes in form and details may be made therein without departing from the spirit and scope of the invention as defined by the appended claims.

What is claimed is:

1. A system for providing predictive queries to a search system having an error correction engine which performs an error correction process for a search query entered by a user and offers a suggested correct query, the system comprising:
a search log database configured to store search queries entered by users;
a recommended predictive query list creating unit configured to create a recommended predictive query list that contains at least one keyword to be provided as the predictive query from the search log database;
an error correction log database configured to store a query pair of a wrong query entered by a user and the suggested correct query offered by the error correction engine and accepted by a user;
a correct query probability calculation unit configured to calculate probability of a correct query with regard to a specific keyword contained in the recommended predictive query list by reading the error correction log database and then comparing the number of wrong queries containing the specific keyword with the number of correct queries containing the specific keyword;
a wrong query list creating unit configured to select the specific keyword as a correct query on the basis of the calculated probability and also to create a wrong query list by extracting wrong queries from query pairs having the specific keyword as suggested correct queries among the query pairs in the error correction log database;
a query indexing unit configured to create index information about correct queries and about wrong queries with regard to the specific keyword on the basis of both the recommended predictive query list and the wrong query list; and
a predictive query creating unit configured to retrieve index information from the query index database and to find a predictive query having the same index information as that of a currently entered query.

2. The system of claim 1, wherein the index information is a linear arrangement of letter units, phoneme units, syllable units, or suffix units derived from separation of each correct query or each wrong query.

3. The system of claim 1, wherein the probability is calculated according to the following Equation:
P(keyword)=Min{1, C(keyword)/W(keyword)},
wherein the term “P(keyword)” denotes the probability that a specific keyword is a correct query, the function “Min{1, A}” denotes the minimum value between numeral values “1” and “A”, the term “C(keyword)” denotes the number of cases where a specific keyword appears in suggested correct queries, and the term “W(keyword)” denotes the number of cases where a specific keyword appears in wrong queries.

4. The system of claim 1, wherein the wrong query list creating unit is further configured to select the specific keyword as a correct query when the probability is equal to or greater than a given reference value.

5. A search system comprising the predictive query providing system set forth in claim 1.

6. A method for providing predictive queries to a search system having an error correction engine which performs an error correction process for a search query entered by a user and offers a suggested correct query, the method comprising:
recording, in a search log database, search queries entered by users and also recording, in an error correction log database, a query pair of a wrong query entered by a user and the suggested correct query offered by the error correction engine and accepted by a user;
creating a recommended predictive query list that contains at least one keyword to be provided as the predictive query from the search log database;
calculating probability of a correct query with regard to a specific keyword contained in the recommended predictive query list by reading the error correction log database and then comparing the number of wrong queries containing the specific keyword with the number of correct queries containing the specific keyword;
selecting the specific keyword as a correct query on the basis of the calculated probability and then creating a wrong query list by extracting wrong queries from query pairs having the specific keyword as suggested correct queries among the query pairs in the error correction log database;
creating index information about correct queries and about wrong queries with regard to the specific keyword on the basis of both the recommended predictive query list and the wrong query list; and
finding a predictive query having the same index information as that of a currently entered query by retrieving index information from the query index database.

7. The method of claim 6, wherein the index information is a linear arrangement of letter units, phoneme units, syllable units, or suffix units derived from separation of each correct query or each wrong query.

8. A computer-readable storage medium storing therein a program executing the predictive query providing method set forth in claim 6.
